(19) United States
(12) Patent Application Publication
(10) Pub. No.: US 2009/0153310 A1
(43) Pub. Date: Jun. 18, 2009

(54) APPARATUS FOR PRODUCING RFID TAG AND RFID TAG EDITING APPARATUS

(75) Inventors: Yasuhisa ICHIKAWA, Nagoya-shi (JP); Yuta INAGAKI, Seto-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: Brother Kogyo Kabushiki Kaisha, Nagoya-shi (JP)

(21) Appl. No.: 12/334,122

(22) Filed: Dec. 12, 2008

(30) Foreign Application Priority Data
Dec. 14, 2007 (JP) 2007-322750

(51) Int. Cl. H04Q 5/22; B65C 9/46

(52) U.S. Cl. 340/10.51; 156/387

(57) ABSTRACT

A tag label printer has a device antenna that can transmit/receive information to/from a RFID circuit element provided with an IC circuit part storing information and a tag antenna that transmits/receive information and performs issuance processing of a RFID label using a tag tape provided with the RFID circuit element in which a storage location URL of RSS data relating to a predetermined news site and a news ticker widget program for performing predetermined display processing relating to the site information provided at the news site are written.

### CROSS-REFERENCE TO RELATED APPLICATIONS

This application claims priority from JP 2007-322750, filed Dec. 14, 2007, the contents of which are hereby incorporated by reference.

### BACKGROUND OF THE INVENTION

1. Field of the Invention

The present invention relates to an apparatus for producing RFID tag and a RFID tag editing apparatus configured to produce a RFID tag for information display using a widget.

2. Description of the Related Art

With a spread of personal computers and penetration of IT network societies, application software in personal computers and small-sized software operating on desktop computers (accessory software, single-function programs and the like) have been proposed in recent years (See JP, A, 2007-251920, for example). Such small-sized software is called widget or gadget (hereinafter simply referred to as “widget”). In general, the widget is executed in a specific runtime environment and those with functions of clock, calendar, dictionary, calculator, weather information and the like are already known.

If the above widget is to be operated on a desktop of personal computer, for example, unlike usual application software, another widget can be easily executed in a single screen without hierarchical movement between menus. As a result, a burden on operation or waiting time can be reduced, and convenience for operators can be improved.

On the other hand, a RFID (Radio Frequency Identification) system in which information is read/written contactlessly between a small-sized RFID tag and a reader (reading device)/writer (writing device) has been prevailing. Using this RFID system, an art in which a storage location (URL information) of a predetermined information providing site stored in a RFID tag is read out by a reader and an access is made to the site so that corresponding information is acquired and displayed has been already proposed, for example. Also, an art to read out various types of application software stored in the RFID tag by the reader and take them into a terminal side has been also proposed.

Similarly to the above application software, if a RFID tag storing the widget is produced, the widget can be easily distributed by delivering the RFID tag to a desired counterpart, but such an art has not existed before. When a RFID tag in which a storage location of an information providing site is written is produced and a direct access is to be made to the information providing site by reading out the storage location, there is a fear that the latest information can not be acquired if information at the site is changed or updated.

### SUMMARY OF THE INVENTION

The present invention has an object to provide an apparatus for producing RFID tag and a RFID tag editing apparatus that can surely display the latest information of a desired information providing site with a simple operation even if information at the site is changed or updated.

### BRIEF DESCRIPTION OF THE DRAWING

FIG. 1 is a system block diagram illustrating an entire RFID tag manufacturing system including an apparatus for producing RFID tag of an embodiment of the present invention.

FIG. 2 is a functional block diagram illustrating a detailed function of a PC and a tag label printer.

FIG. 3 is a block diagram illustrating an example of functional configuration of a RFID circuit element provided at a RFID label.

FIG. 4 is a diagram illustrating an example of a memory map showing data configuration in a memory part of an IC circuit part of the RFID circuit element provided at the RFID label.

FIG. 5 is a diagram for conceptually illustrating a main flow of information in the system.

FIG. 6 is a diagram illustrating a display example of a program for producing tag displayed on a display part of the writing-side PC.

FIG. 7 is a diagram illustrating an example of an operation of drop input of URL data by an image on the display part.

FIG. 8 is a diagram illustrating a display example of the program for producing tag in a state where required information is entered and displayed.

FIG. 9 is a top view illustrating an example of an appearance of a RFID label produced by the tag label printer.

FIG. 10 is a diagram illustrating an operation to read out a widget program from the RFID label and install it and its display example.

FIG. 11 is a diagram illustrating a display example obtained by reading an URL of an RSS site from the RFID label and displaying site information in a window of a news ticker widget.

FIG. 12 is a diagram illustrating a display example when a WEB page of the corresponding news site is displayed by link from a headline.

FIG. 13 is a flowchart illustrating a control procedure of the program for producing tag executed by a control circuit of the PC.

FIG. 14 is a flowchart illustrating a detailed procedure of printer check processing executed at Step S100 in FIGS. 13, 19.

FIG. 15 is a flowchart illustrating a detailed procedure of template file setting processing executed at Step S200 in FIG. 13.

FIG. 16 is a flowchart illustrating a detailed procedure of text object replacement processing executed at step S300 in FIG. 13.

FIG. 17 is a flowchart illustrating a detailed procedure of writing information setting processing executed at Step S400 in FIG. 13.

FIG. 18 is a flowchart illustrating a detailed procedure of print-screen preview processing executed at Step S500 in FIG. 13.

FIG. 19 is a flowchart illustrating a detailed procedure of RFID label production processing executed at Step S600 in FIG. 13.

FIG. 20 is a diagram illustrating a display example when a plurality of RSS sites is cumulatively registered by the news ticker widget.

FIG. 21 is a diagram illustrating a display example of the program for producing tag in which three combinations of an RSS site and a widget can be entered.

### DETAILED DESCRIPTION OF THE PREFERRED EMBODIMENTS

An embodiment of the present invention will be described below referring to the attached drawings.

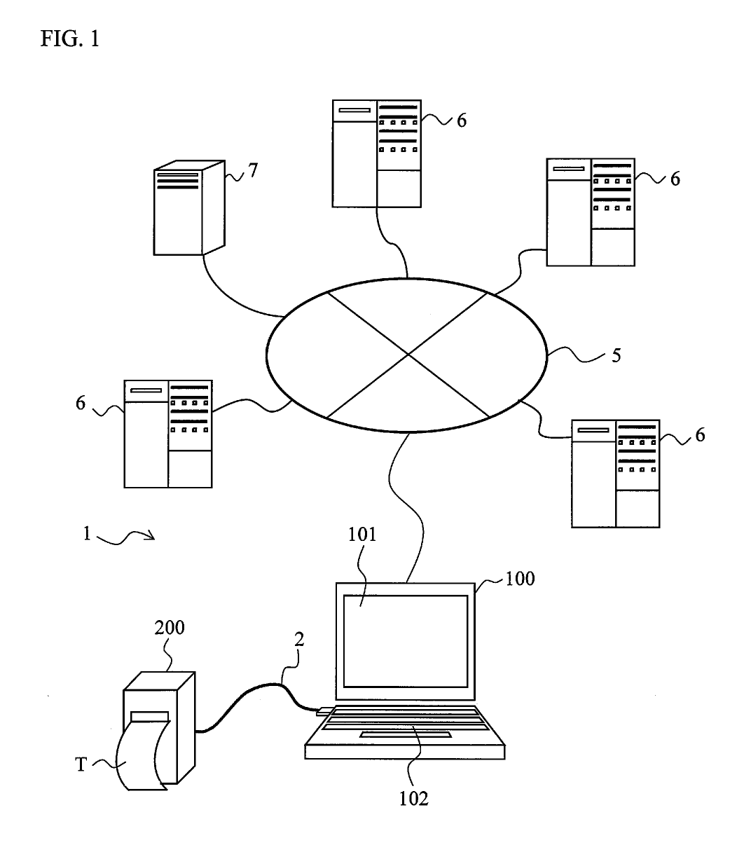

FIG. 1 is a system block diagram illustrating an entire RFID tag manufacturing system including an apparatus for producing RFID tag of this embodiment.

A RFID tag manufacturing system 1 shown in FIG. 1 comprises a tag label printer 200 as an apparatus for producing RFID tag configured to produce a RFID label (RFID tag) T and a PC terminal 100 as a RFID tag editing apparatus having a display part 101, an operation part 102 and the like (hereinafter simply referred to as “PC 100” or “writing-side PC 100”, as appropriate).

The tag label printer 200 is connected to the PC 100 through a connecting device 2 such as a USB cable, for example. The PC 100 is connected to an RSS server 7 through a wired or radio communication network 5 such as the Internet, for example. The RSS server 7 and the PC 100 are connected to a plurality of information providing servers 6 through the communication network 5 capable of access.

The RSS server 7 stores and maintains RSS data (details will be described later) capable of reading out. The information providing server 6 is a so-called WEB server and the like and manages information providing sites corresponding to storage location information (URL and the like. The details will be described later) included in the RSS data.

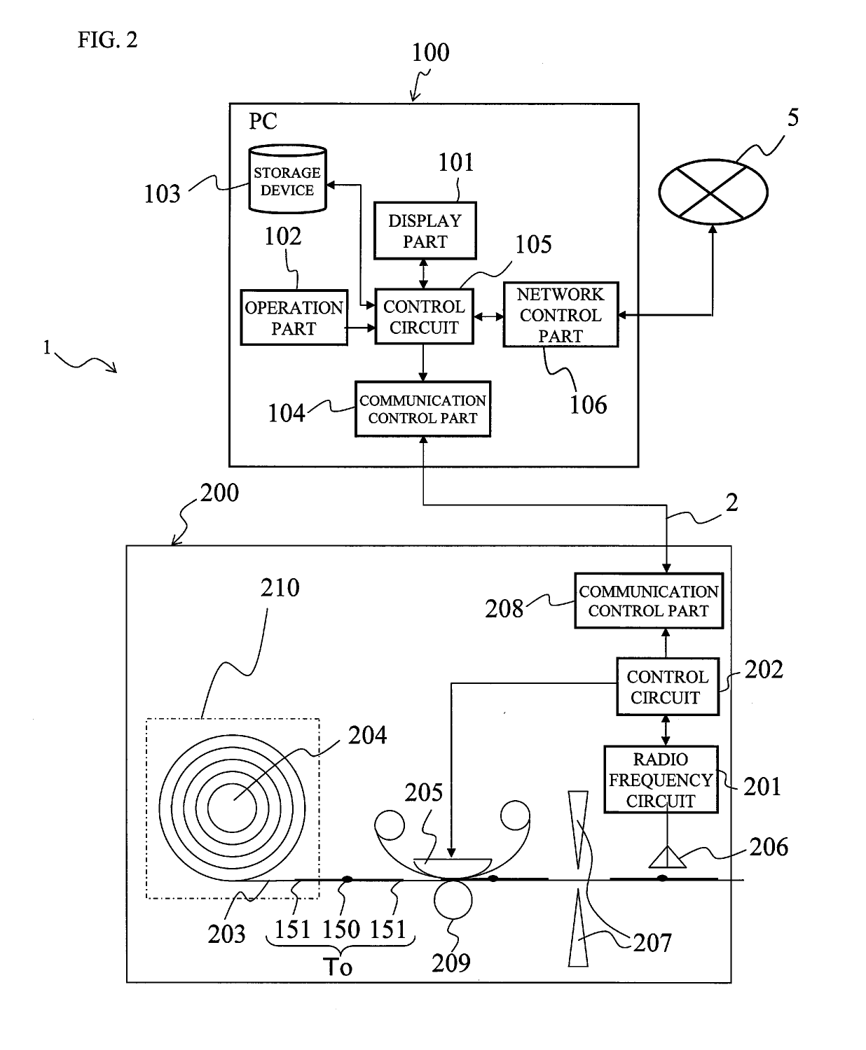

FIG. 2 is a functional block diagram illustrating a detailed function of the PC 100 and the tag label printer 200 constituting the above RFID tag manufacturing system 1.

In FIG. 2, the PC 100 has the display part (display device) 101, which is a display apparatus to make predetermined display such as various input screens, output screens, the operation part (operating device) 102 provided with appropriate buttons, keys, mouse and the like for operation input by an operator, a storage device 103 configured to store various information to be recorded in the RFID label T, information relating to the RSS server 7 and the like, a communication control part 104 configured to control communication performed with the tag label printer 200 via the connecting device 2, a network control part 106 configured to control communication performed through the communication network 5, and a control circuit 105 configured to control operation of the entire PC 100 including the display part 101, the operation part 102, the storage device 103, the communication control part 104, and the network control part 106.

The tag label printer 200 has a tag-tape-roll holder part 210, a print head 205 (printing device), a device antenna (communication device) 206, a radio frequency circuit 201, a control circuit 202, a communication control part 208 configured to control communication with the PC 100 through the connecting device 2, a cutter 207, and a feeding apparatus (feeding device) 209.

The tag-tape-roll holder part 210 is configured so that a cartridge, not shown, provided with the tag tape roll 204 (or the tag tape roll 204 may be directly attached) can be detachably attached. The tag tape roll 204 has a tag tape 203 (tag medium) provided with RFID circuit elements To with a predetermined interval wound around it. The RFID circuit element To is provided with an IC circuit part 150 storing information and a tag antenna (tag antenna) 151 connected to the IC circuit part 150.

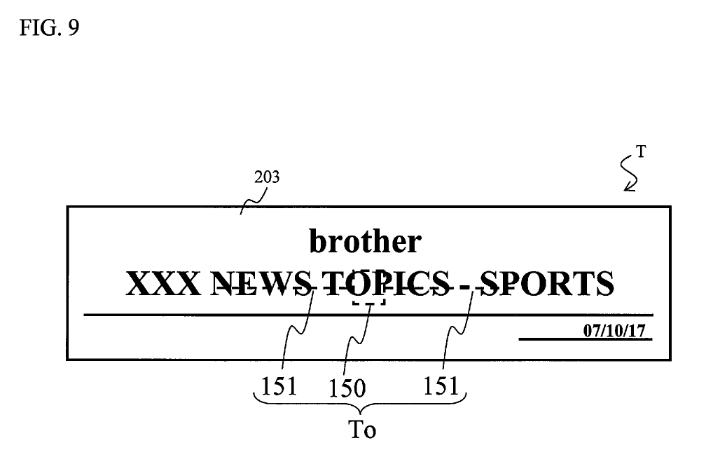

The print head 205 makes a desired print on a predetermined print region (See FIG. 9, which will be described later) corresponding to the RFID circuit element To in the tag tape 203 fed out of the tag tape roll 204. The device antenna 206 performs information transmission/reception via radio communication with the RFID circuit element To. The cutter 207 cuts the tag tape 203 for which the print on the tag tape 203 and the information writing in the RFID circuit element To have been finished to a predetermined length to produce the RFID label T. The feeding apparatus 209 is provided opposite the print head 205 and configured to feed the tag tape roll 204 under control of the control circuit 202.

The radio frequency circuit 201 and the control circuit 202 generate access information to the IC circuit part 150 of the RFID circuit element To, transmits it to the RFID circuit element To through the device antenna 206 and writes information in the IC circuit part 150 of the RFID circuit element To. The control circuit 202 is connected to the PC 100 through the communication control part 208 and the connecting device 2 so that information can be transmitted/received with the PC 100.

In the above configuration, when the RFID label T is to be produced by the tag label printer 200, an operator conducts setting input of various information to be stored in the RFID circuit element To of the RFID label T, print information to be printed on the surface of the RFID label T and the like and input of production instruction of the RFID label T through the operation part 102 of the PC 100. Then, a production instruction signal corresponding to the production instruction is transmitted to the tag label printer 200 through the connecting device 2. The tag label printer 200 having received the production instruction signal makes print corresponding to the setting input information by the print head 205 under control of the control circuit 202. The tag label printer 200 generates access information by the radio frequency circuit 201 and transmits it to the RFID circuit element To through the device antenna 206. As a result, various information is written in the IC circuit part 150 of the RFID circuit element To and the RFID label T is produced.

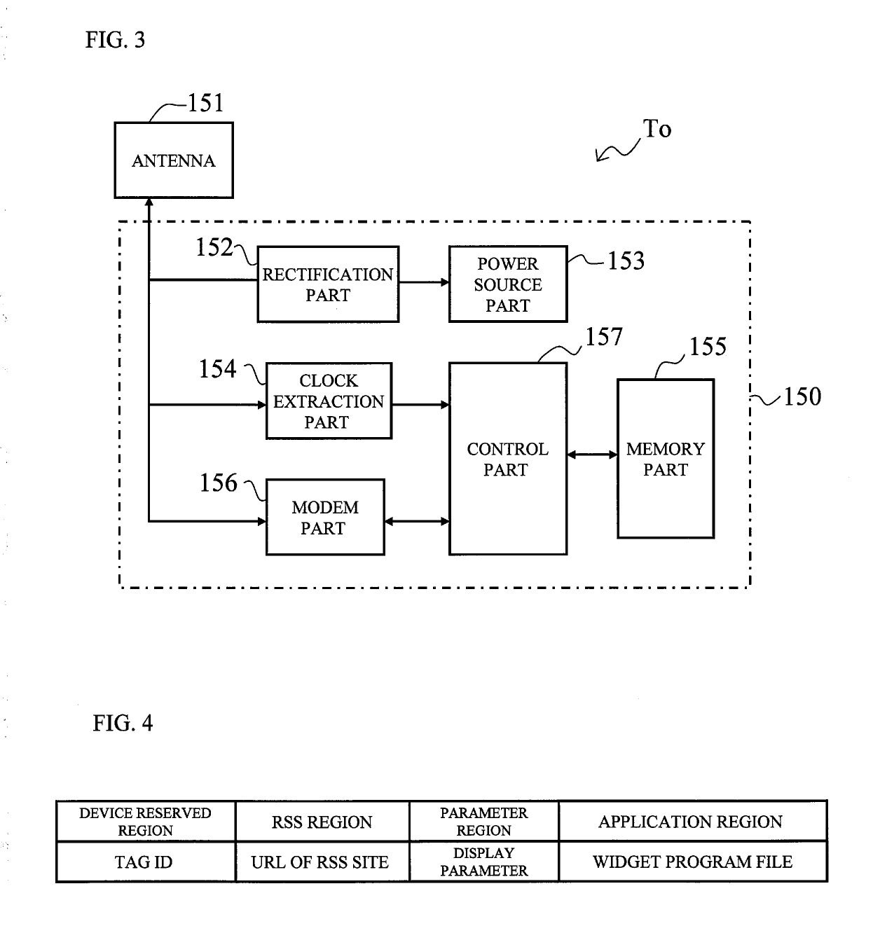

FIG. 3 is a block diagram illustrating an example of functional configuration of the RFID circuit element To provided at the RFID label T.

In FIG. 3, the RFID circuit element To has the tag antenna 151 configured to transmit/receive a signal contactlessly with the device antenna 206 of the tag label printer 200, as mentioned above, and the IC circuit part 150 connected to the tag antenna 151.

The IC circuit part 150 has a rectification part 152 configured to rectify an interrogation wave received by the tag antenna 151, a power source part 153 configured to accumulate energy of the interrogation wave rectified by the rectification part 152 so as to make it a driving power source, a clock extraction part 154 configured to extract a clock signal from the interrogation wave received by the tag antenna 151 and to supply it to a control part 157, a memory part 155 that can store predetermined information signals, a modem part 156 connected to the tag antenna 151, and the control part 157 configured to control operation of the RFID circuit element To through the memory part 155, the clock extraction part 154, the modem part 156 and the like.

The modem part 156 demodulates a communication signal from the device antenna 206 of the tag label printer 200 received by the tag antenna 151 and modulates a reply signal from the control part 157 and transmits it from the tag antenna 151 as a response wave (a signal containing a tag ID, which is identification information).

The clock extraction part 154 extracts a clock component from the received signal and extracts it to the control part 157 and supplies the clock corresponding to a frequency of the clock component of the received signal to the control part 157.

The control part 157 executes basic control such as interpretation of a received signal demodulated by the modem part 156, generation of a reply signal based on the information signal stored in the memory part 155, reply of the reply signal by the modem part 156 from the tag antenna 151 and the like.

Here, the biggest characteristic of this embodiment is that when the tag label printer 200 is to produce the RFID label T, an URL of an RSS site in which RSS data of a site providing predetermined information is stored and a widget for causing the PC terminal (which will be described later) on a reading side to acquire and display the information provided by the site (site information) are written in the RFID circuit element To.

The RSS is a system configured to deliver, acquire, and display update information of the predetermined information providing site (including update time and date, various bibliographic items). In this embodiment, the RSS site managed in the above-mentioned RSS server 7 collects URL of predetermined news sites (managed in the information providing server 6) as the information providing sites and generates/stores RSS data.

The widget is a program in a simple form that can be executed by using a specific application (or command set and the like included in a widget engine prepared in a basic OS) (also referred to as gadget). Typically, the widget is an application software in personal computers and small-sized software operated on the desktop (accessory software, single-function programs and the like).

FIG. 4 is a diagram illustrating an example of a memory map showing data configuration in the memory part 155 of the IC circuit 150 in the RFID circuit element To provided at the RFID label T.

In the example shown in FIG. 4, in a storage space in the memory part 155 of the IC circuit part 150 in the RFID circuit element To, a device reserved region, an RSS region, a parameter region, and an application region are provided in each division.

The device reserved region is a storage region in which a tag ID uniquely defined in order to identify an individual RFID circuit element To (UID) and the like is stored and a user can not write in freely.

The RSS region is a region in which storage location information (URL) of an RSS site (site that delivers RSS data), which will be described later, is stored.

The application region is a region that stores an execution file (or its compressed file) of the widget program. The widget program can be simple description to invoke the command set using a markup language (“XML” and the like, for example) or a script language, and the capacity of the program file itself can be extremely small. Thus, the program file can be easily recorded as it is (or the compressed file can be recorded) in the application region. Incidentally, in this example, a widget of the Ticker-type RSS reader that accesses a news site for display is written in, as will be described later.

The parameter region is a region that stores various display parameters (display instruction information) when display is executed at the display part 101 of the PC 100 based on the widget program. The display parameters are considered to include display portion/position of a display window (display position information), size of the display window, character colors, background colors, display frequency and the like.

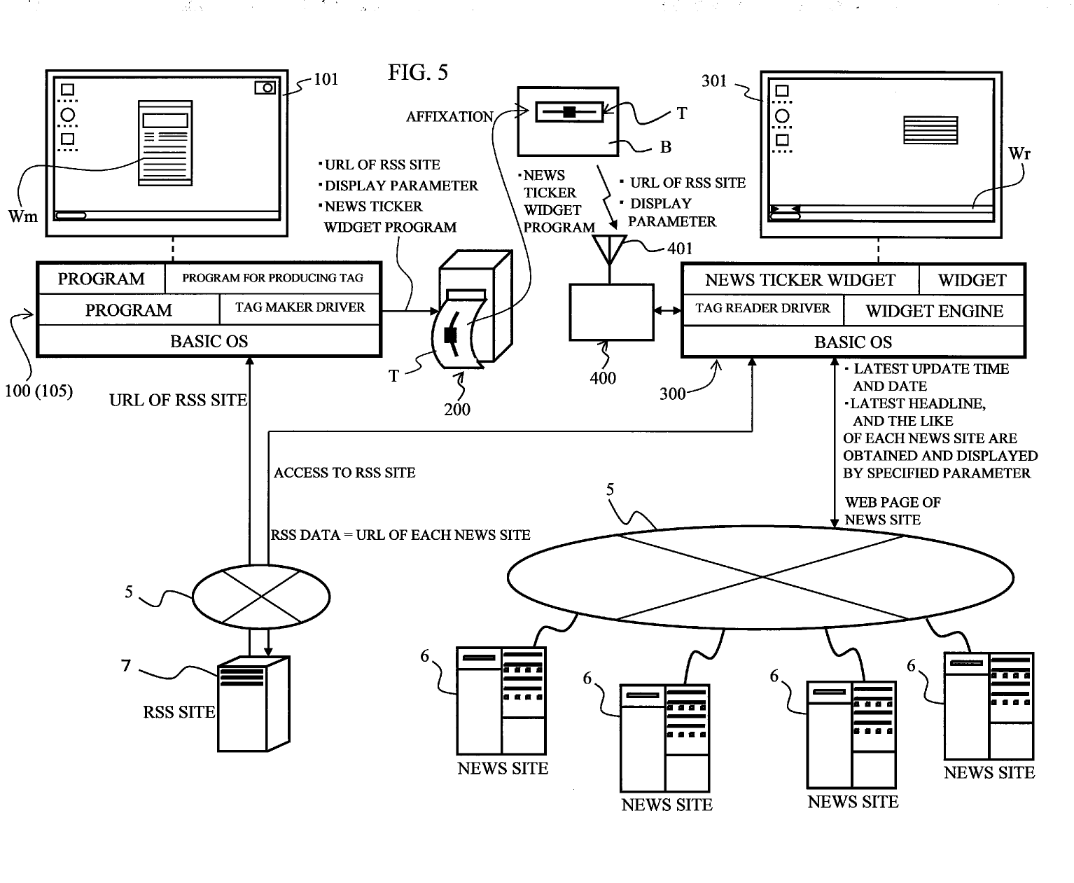

In this embodiment, the RFID label T in which the above information is stored in the RFID circuit element To is produced, and a tag reader 400 (which will be described later) reads out the information from the RFID label T. By this arrangement, the URL (storage location information) of the RSS site can be read out from the RSS region of the memory part 155, and the widget program stored in the application region of the memory part 155 can be also acquired. When a PC terminal 300 on the reading-out side connected to the tag reader (which will be described later) accesses the RSS site and acquires the RSS data, an access can be made on the reading-out side PC terminal to the URL of the predetermined information providing site contained in the acquired RSS data. By this arrangement, the reading-out side PC terminal can acquire the site information provided at the information providing site and display the acquired information using the widget program acquired from the application region. The details of the contents will be sequentially described below using FIGS. 5 to 21.

FIG. 5 is a diagram for conceptually illustrating main flow of information in this embodiment.

In FIG. 5, the control circuit 105 on the writing-side PC 100 is provided with a basic OS (operating system), a tag maker driver (program group) configured to control the tag label printer 200, and a program for producing RFID label. The writing-side PC 100 conducts display on the display part 101 based on the program for producing tag and receives inputs of setting and instructions from an operator through the operation part 102. Then, using the tag maker driver, information writing in the RFID circuit element To at the tag label printer 200 and print on the tag tape 203 are performed so as to produce the RFID label T. At the writing in the RFID label T, as mentioned above, the URL of the RSS site is written in the RSS region provided at the memory part 155 of the RFID circuit element To, the widget of the Ticker-type RSS reader (hereinafter referred to as news ticker widget) is written in the application region, and the display parameters are written in the parameter region.

On the other hand, in FIG. 5, the above-mentioned tag reader 400 and the reading-out side PC terminal 300 (in the same configuration as the PC 100, for example. Hereinafter referred to as “reading-side PC 300” as appropriate) are provided.

The tag reader 400 reads out information from the RFID label T (affixed to an appropriate article B in this example) via radio communication through the antenna 401. To the tag reader 400, the reading-side PC 300 is connected.

The reading-side PC 300 is connected to the RSS server 7 and the various information providing servers 6 through the communication network 5 capable of access, similarly to the above. The reading-side PC 300 (in detail, a control circuit similar to the control circuit 105, for example) is provided with the basic OS (operating system) and the tag reader driver (program group) that controls the tag reader 400. In this example, a widget engine containing a command set (program group) that operates the widget program, which will be described later, is provided (reading may be conducted from the RFID label T as with the widget).

The reading-side PC 300 reads the URL of the RSS site stored in the RFID circuit element To of the RFID label T through the tag reader 400 using the tag reader driver, reads the widget program (news ticker widget Wr) and installs it in the reading-side PC 300. At this time, through the tag reader 400, the display parameter read out of the parameter region of the memory part 155 of the RFID label T is also acquired. If an authentication tag for ensuring security as will be described later is issued with the RFID label T, it may be so configured that reading-out is not performed (or read-out information is not effected) unless the authentication tag corresponding to the RFID label T is also read out at the reading-out from the RFID circuit element To. By this arrangement, virus contamination caused when a malicious person has a tag with virus read out can be prevented.

The reading-side PC 300 accesses the RSS site based on the acquired URL of the RSS site using the news ticker widget Wr and acquires the RSS data. Then, the PC acquires the URL (may be one or plural) of the predetermined news site contained in the RSS data and accesses each of the URLs. Then, the PC acquires latest headlines of each news site (may be summary of the latest news topics or the predetermined number of initial character strings of the document contents, for example) and update time and date (update time and date information) and makes text display on the display part 301 using the command set of the widget engine (the detail will be described later). When display is made on the display part 301, it is displayed in a display mode based on the display parameter acquired as above. In this example, the news ticker widget can be displayed/executed at the same time with the other plurality of widgets executed using the same widget engine.

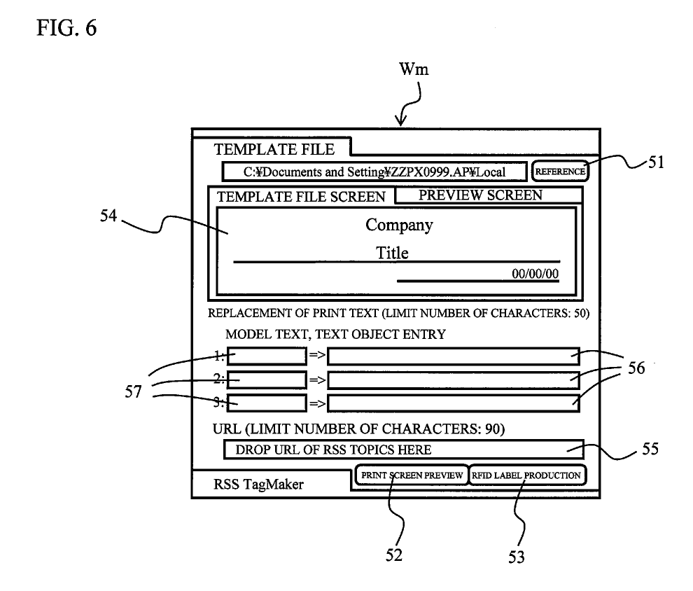

FIG. 6 is a diagram illustrating a display example displayed on the display part 101 of the writing-side PC 100 based on the above-mentioned program Wm for producing RFID label when the RFID label T is to be produced.

In the display example shown in FIG. 6, a template file screen 54, an entry column 55 for URL of the RSS site, an entry column 56 for text object, and an entry column 57 for model text are provided.

When an operator is to produce the RFID label T, a template file as a template of a print image to be printed on the surface of the tag tape 203 is used. The operator selects one of the template files prepared in plural in a wide variety by specifying a file path from a reference button 51 (or direct input on the operation part 102) and has it displayed as the template file screen 54. At this time, a model text (“Company”, “Title”, “00/00/00” in the shown example) included in the selected template file is displayed on the model-text entry column 57. In this state, the operator enters a text object corresponding to each model text in the text-object entry column 56. As a result, print image data in which each model text set for the template file is replaced by the contents of the corresponding text object is produced with the same layout and character size. The print image can be displayed using a print-screen preview button 52. As mentioned above, the print contents on the print region in the tag tape 203 can be determined.

The RSS-site URL entry column 55 is a column for specifying storage location information (URL) to be written in the RSS region of the memory part 155 in the RFID circuit element To as mentioned above. The operator can directly enter the URL in this entry column 55 by the operation part 102 (such as a keyboard). The URL can be also entered by operation of drag-and-drop executed using a pointing device such as a mouse in a so-called GUI (Graphical User Interface) environment (the detail will be described later).

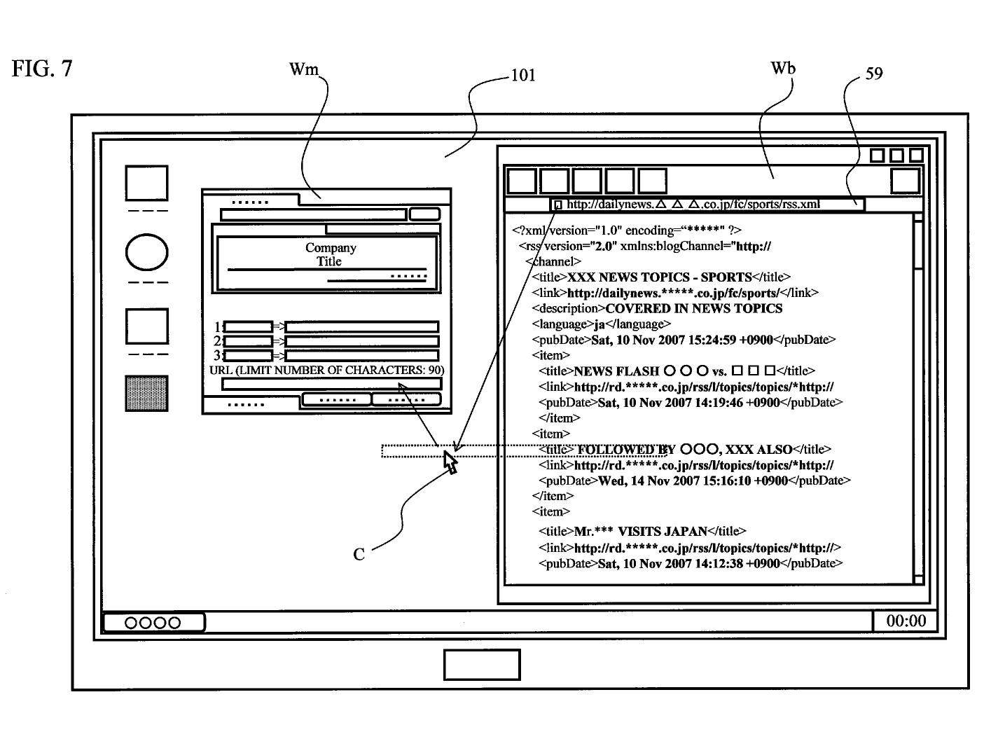

FIG. 7 is a diagram illustrating an example of an operation in which the URL data is drop-input in the RSS-site URL entry column 55 by an image on the display part 101. In the illustrated example, display in the general GUI environment and file operation are supposed to be available.

In FIG. 7, on the display part 101, an application of a WEB browser Wb accessing the RSS site and displaying the RSS data (source of an XML file) is also displayed in addition to the program Wm for producing tag. The operator can easily input the URL data by dragging the URL data (character string of the URL or a corresponding icon) by a cursor C from a URL display column 59 in the WEB browser Wb and dropping it in the URL entry column 55 in the program Wm for producing tag.

As mentioned above, the URL character string may be input in the URL entry column 55 directly by keyboard input, or, though not particularly shown, the URL may be input by fully specifying and copying the URL character string in the URL display column 59 of the WEB browser Wb using cursor specification and the like and pasting in the URL entry column 55 of the program Wm for producing tag.

If an input is made into the URL entry column 55 as above, which is appropriate URL data, and information acquired from the URL is an XML file including RSS or RDF, a character string of the URL is displayed in the URL entry column 55. In the illustrated example, since the character string of the input URL is within the limit number of characters of 90 characters (which will be described later), a background of the URL entry column 55 remains white. Also, since a text object corresponding to a title of the model text (“Title”) has not been entered yet, the title “XXX News Topics-Sports” described in the XML file of the RSS data is entered/displayed as the text object corresponding to the title as it is.

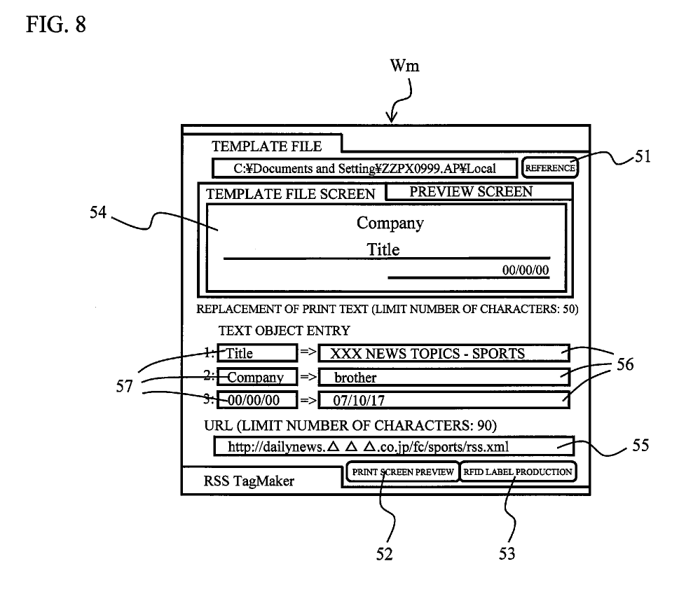

As mentioned above, as shown in FIG. 8, the template file screen 54 in a state where required information has been entered and displayed is realized. Then, by operating a RFID label producing button 53, in the tag label printer 200, print of the print image data on the tag tape 203 and writing of the URL of the RSS site in the RFID circuit element To (and display parameters separately set, program files of the news ticker widget) is conducted, and the RFID label T is produced. When such RFID label T is to be issued, an authentication tag (not particularly shown) for ensuring security as mentioned above may be issued separately.

FIG. 9 is a top view illustrating an example of an appearance of the RFID label T produced by the tag label printer 200 by the above operation.

In FIG. 9, on the surface of the RFID label T, the respective corresponding character strings of the text object (See FIG. 8) are printed with the display mode (size and layout of the characters; See FIG. 8) of each model text as it is. Inside the RFID label T, the RFID circuit element To (displayed by a broken line in the figure) provided with the tag antenna 151, which is a dipole antenna, and the IC circuit part 150 is provided.

On the other hand, as mentioned above, the reading-side PC 300 accesses the RSS site with the URL recorded in the RSS region of the memory part 155 in the RFID circuit element To provided at the RFID label T and acquires the URL of a predetermined news site by executing the news ticker widget when the operator merely brings the RFID label T produced as above to the tag reader 400, further accesses the news site with the URL and acquires the site information (news headline and the like) provided by the site, and can make display on the display part 301 in a display mode according to the display parameter recorded in the parameter region of the memory part 155. Specific operation procedures of such news ticker widget and a display example on the display part 301 realized by that will be described referring to the drawings.

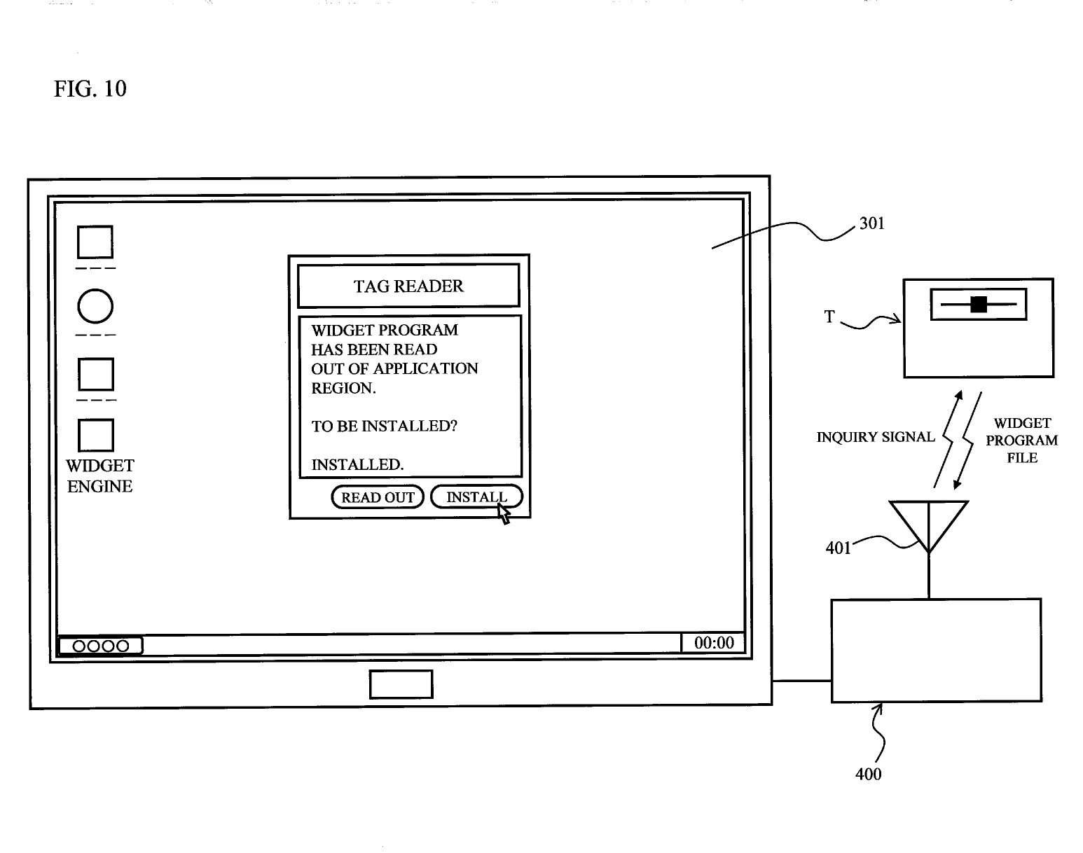

First, as mentioned above, the program itself of the news ticker widget is read out of the application region in the memory part 155 of the RFID circuit element To of the RFID label T and installed in the reading-side PC 300. At this time, as shown in FIG. 10, for example, the file of the widget program is read out of the application region of the memory part 155 using an application for tag reader control (using a tag reader driver) and is installed in the reading-side PC 300.

Then, the program of the installed news ticker widget is started. When the widget program is to be started, it is necessary to bring the widget engine into an effectively operative state, for example. If the widget engine is incorporated in the basic OS in advance, the starting operation of the widget engine is not necessarily needed.

In a state where the news ticker widget is started, the RFID label T is located close to the reader antenna 401 of the tag reader 400. By this arrangement, information stored in each region of the memory part 155 of the RFID circuit element To in the RFID label T is automatically read out. Among them, an access is made to the RSS site based on the URL read out of the RSS region of the memory part 155, an access is made to each news site from the URL included in the RSS data acquired from that, and the site information is acquired from those news sites.

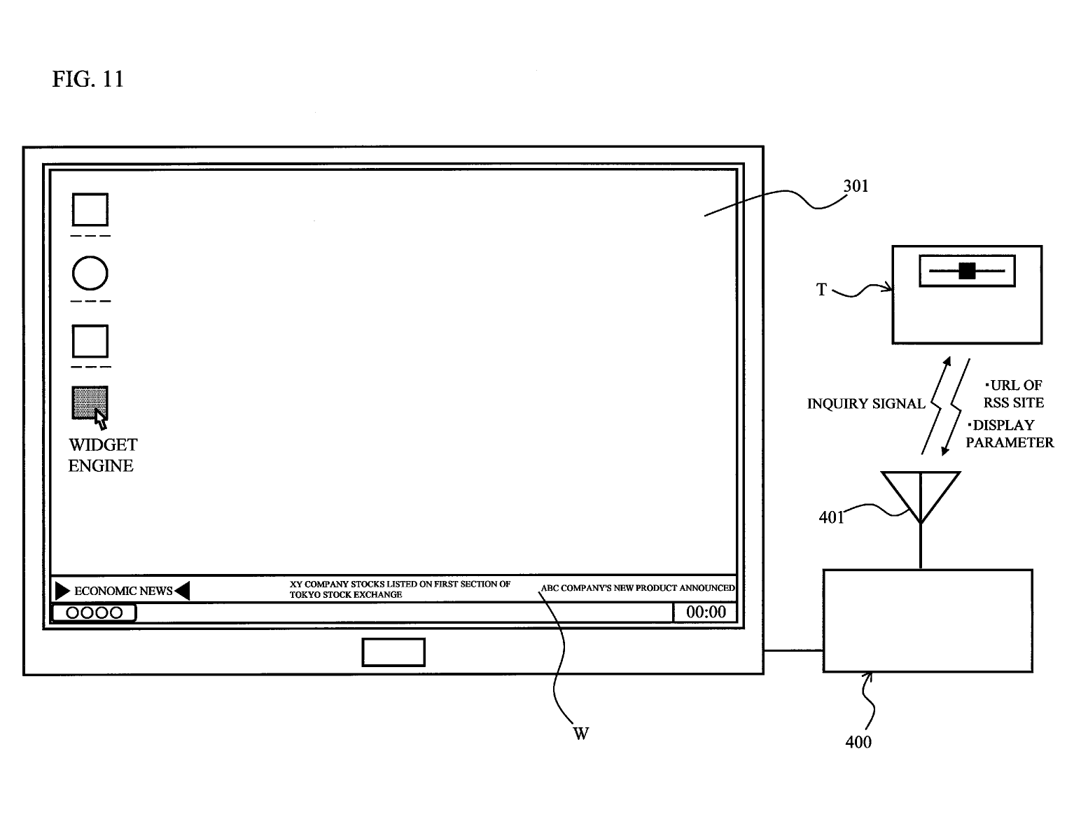

The site information acquired as above is displayed in a window W as shown in FIG. 11. At this time, display is made according to the display parameter read out of the parameter region of the memory part 155. In the illustrated example, according to the display parameter, the window W with a height of one line of the character string over the entire width in the right and left on the lower side of the screen (=display portion) of the display part 301. Then, the name of the RSS site “Economic News” is displayed on the left-side end in that, while outline topics, headlines of first character strings and the like of the news site are displayed while scrolling laterally in the most part of the right hand side. If the latest update time and date as update information is also displayed with each headline or particularly if the latest update time and date is relatively new, characters such as “New” representing the fact may be also displayed.

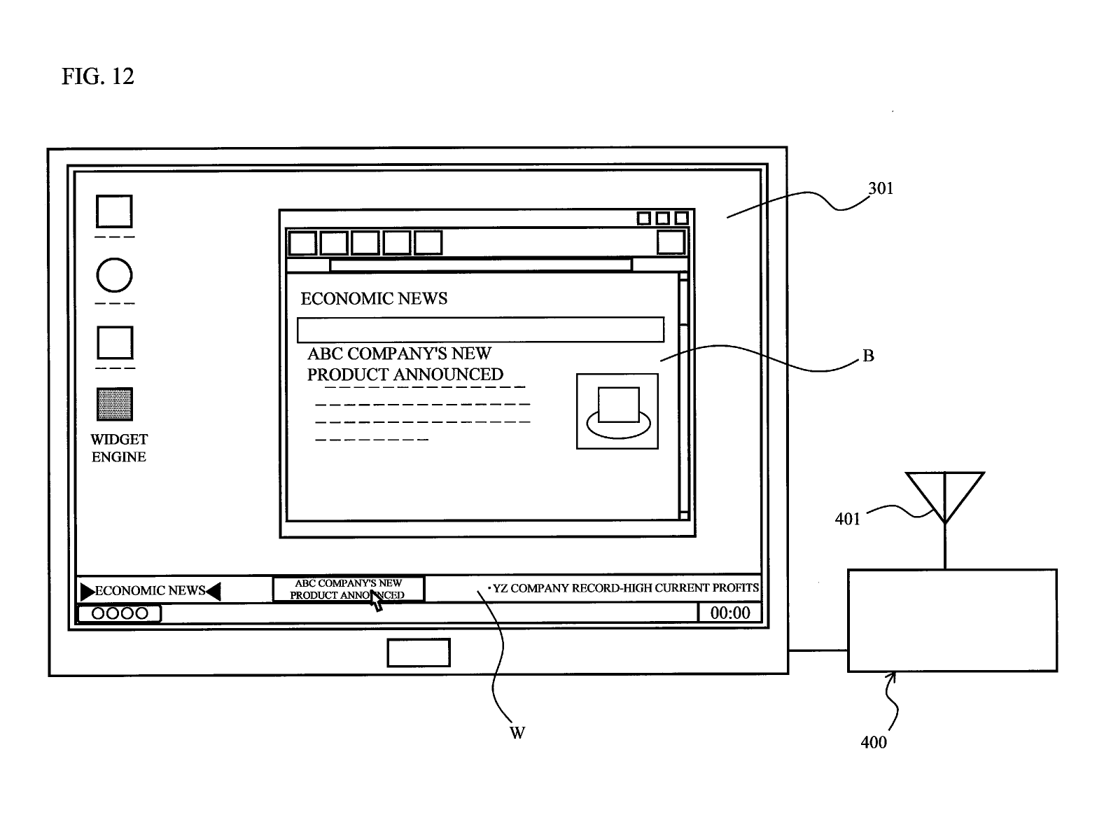

The display part of the headline displayed in the window W is linked with the corresponding URL (so-called hyper shortcut in the GUI environment), and by specifying the headline and carrying out execution operation, a direct access can be made to the corresponding site, which can be fully displayed as a WEB page B automatically by a browser and the like (See FIG. 12). As mentioned above, even without displaying all the predetermined news sites from the beginning by the browser, an operator can easily list outlines of the update states and latest site information and efficiently detect/browse information by fully displaying those considered to be required among them by the browser immediately.

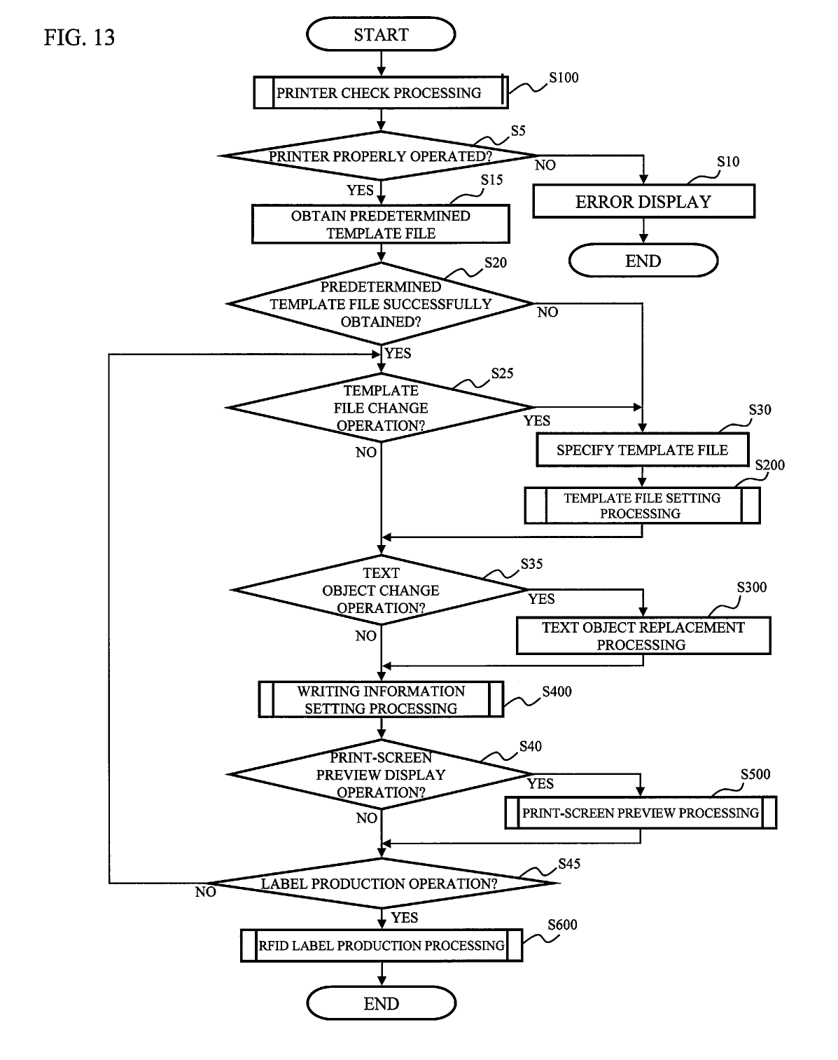

FIG. 13 is a flowchart illustrating a control procedure executed by the control circuit 105 of the PC 100 when the RFID label T with the configuration shown in FIG. 9 is to be produced.

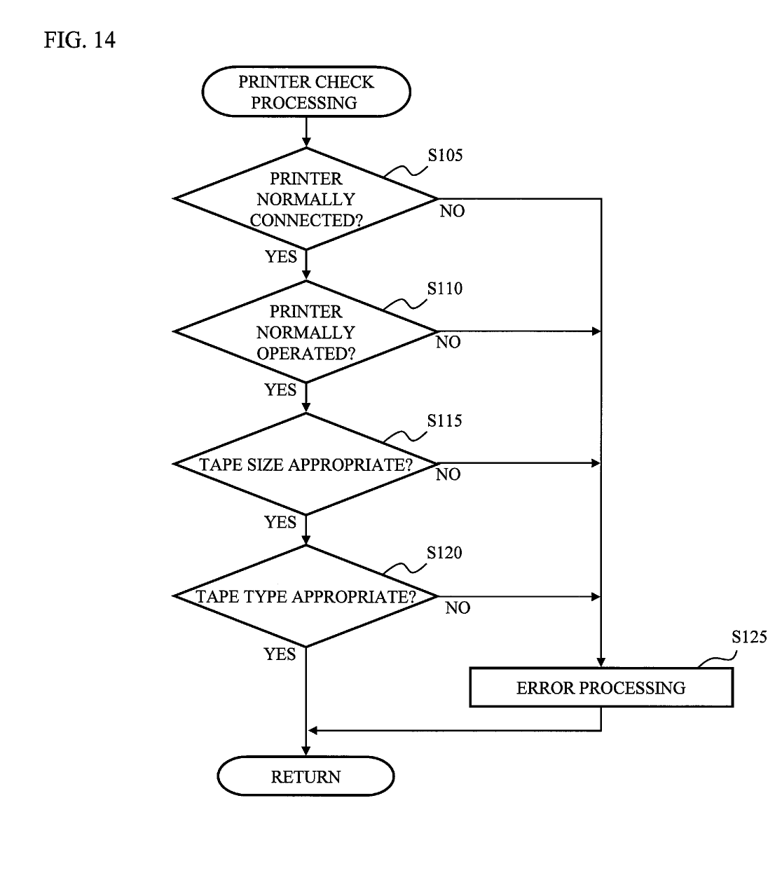

In FIG. 13, first at step S100, printer check processing configured to check connection with the tag label printer 200 and other operating states (See FIG. 14, which will be described later) is performed. Then, the routine goes to Step S5, where it is determined whether a result of the check processing is favorable or not, that is, whether the tag label printer 200 is in an appropriate operable state or not.

If the result of the printer check processing is not favorable, the determination at Step S5 is not satisfied, that is, it is considered that some failure occurs at the tag label printer 200 and the printer can not be properly operated, and the fact is displayed on the display part 101 at Step S10 and this flow is finished. On the other hand, if the result of the printer check processing is favorable, the determination at Step S5 is satisfied, and the routine goes to Step S15.

At Step S15, a default template file set to an initial setting in advance is searched by the program for producing tag from the storage device 103 and acquired.

Subsequently, the routine goes to Step S20, where it is determined if the default template file was successfully acquired at Step S15 or not. If the default template file is detected and acquired from the storage device 103, the determination is satisfied, and the routine goes to Step S25.

At Step S25, it is determined through an input on the operation part 102 whether or not the operator has stopped use of the default template file acquired at Step S15 and instructed change to another template file. If the instruction to change the template file has not been given, the determination is not satisfied, and the routine goes to Step S35.

On the other hand, in the determination at Step S20, if the default template file cannot be acquired from the storage device 103, the determination is not satisfied, and the routine goes to Step S30. Also, in the determination at Step S25, if an instruction to change the template file has been given, the determination is satisfied, and the routine goes to Step S30.

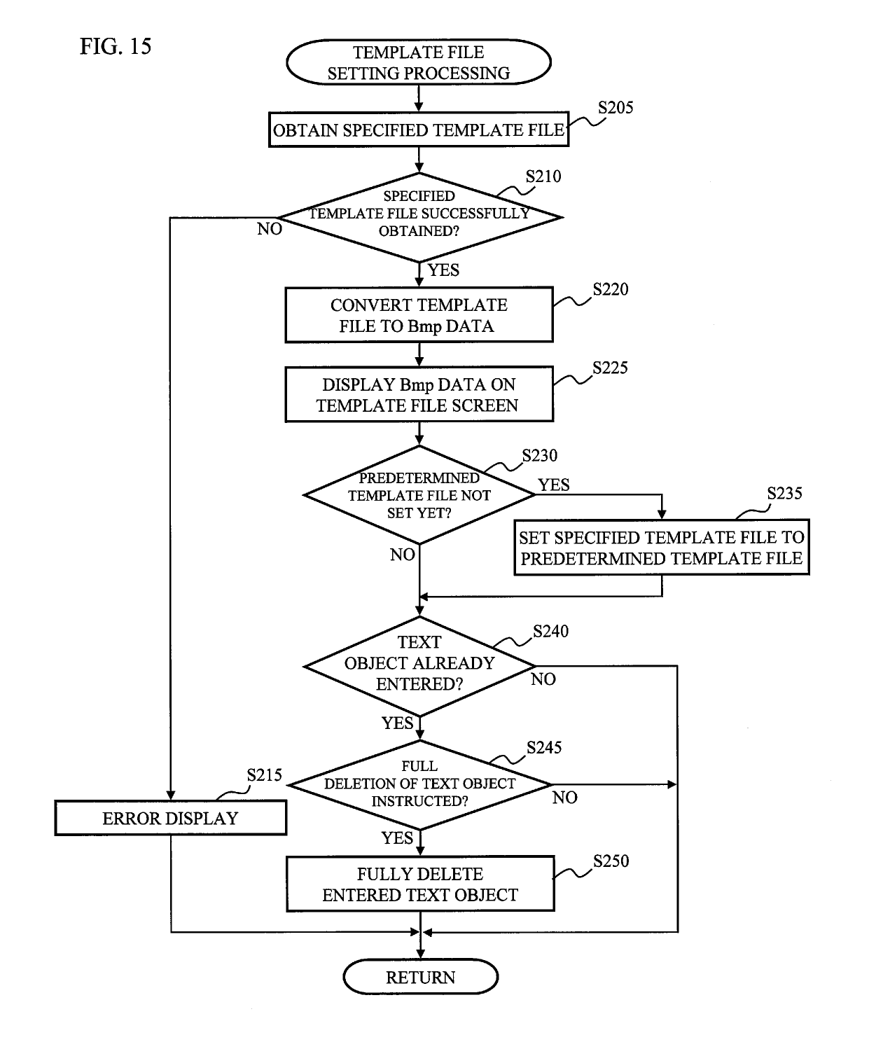

At Step S30, a specification input of an arbitrary template file (by use of the reference button 51 as mentioned above and the like; see FIG. 6) is received from the operator. Then, at Step S200, various settings and display are made for a new template file at template file setting processing (See FIG. 15, which will be described later) and then, the routine goes to Step S35.

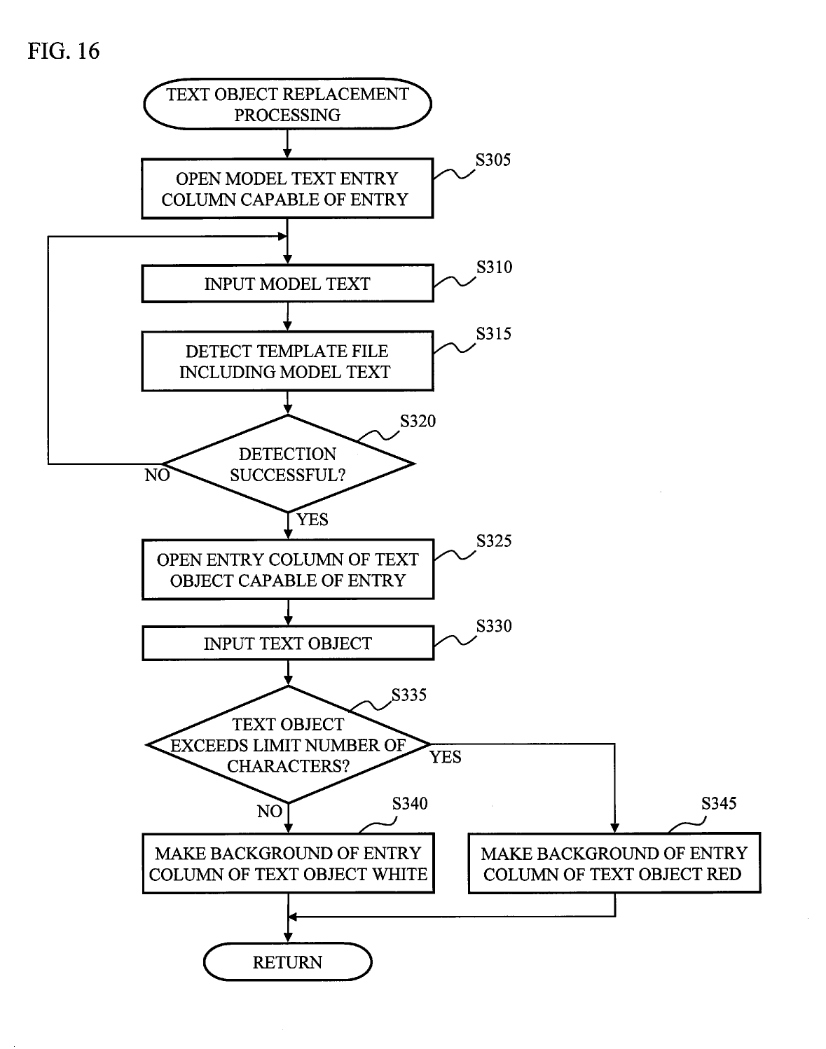

At Step S35, it is determined whether or not the operator has input an instruction to change the text object through the operation part 102. If the instruction to change the text object has not been given, the determination is not satisfied, and the routine goes to Step S400. On the other hand, if the instruction to change the text object has been given, the determination at Step S35 is satisfied, and after detection of the template file by the new model text and input of the text object are carried out in text object replacement processing at Step S300 (See FIG. 16, which will be described later), the routine goes to Step S400.

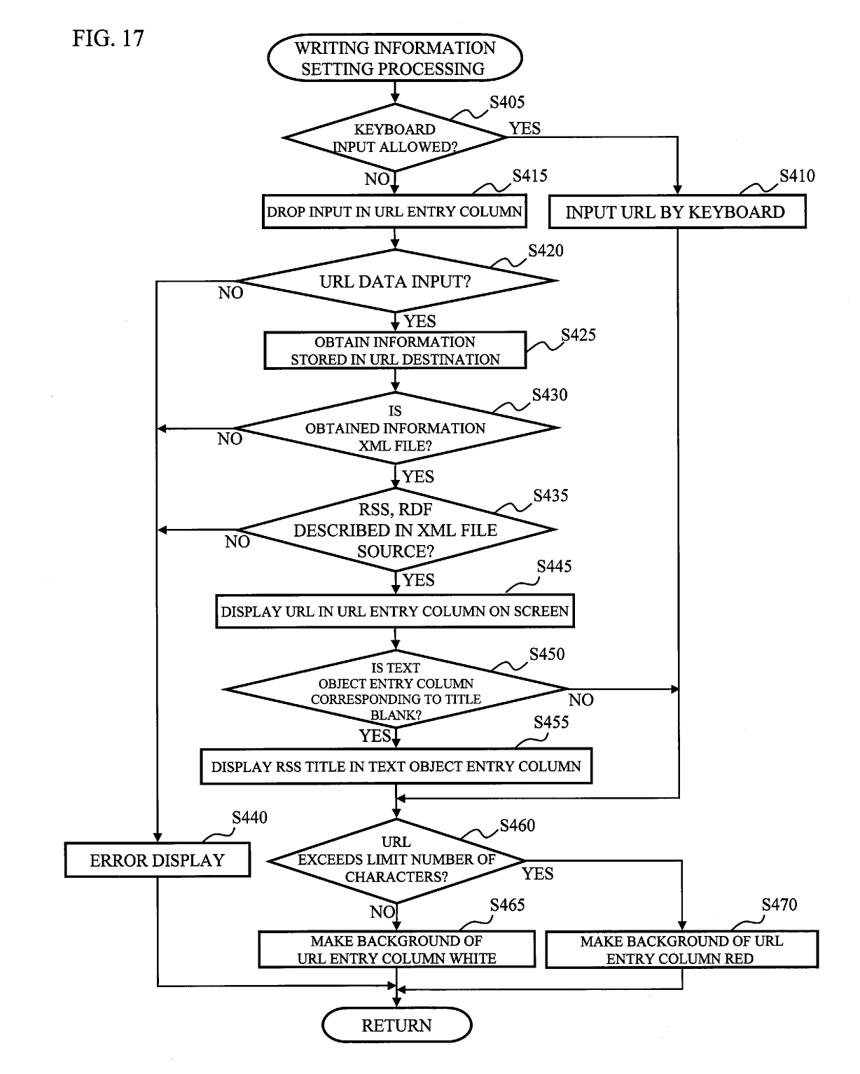

At Step S400, writing information setting processing in which various settings are made on information to be written in the memory part of the RFID circuit element To (See FIG. 17, which will be described later), and the routine goes to Step S40.

At Step S40, it is determined whether or not the operator has input an instruction to preview-display the print screen through the operation part 102 (by pressing the print-screen preview button 52 in FIG. 6 and the like). If the instruction for print-screen preview display has not been given, the determination is not satisfied, and the routine goes to Step S45. On the other hand, if the instruction for print-screen preview display has been given, the determination at Step S40 is satisfied, and the routine goes to Step S500.

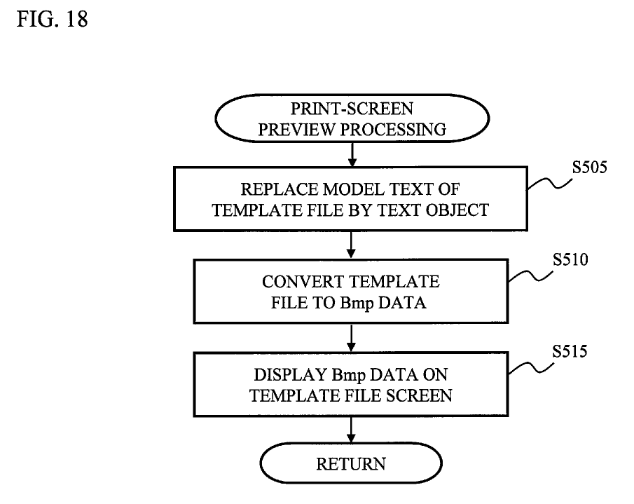

At Step S500, print-screen preview processing is performed. That is, to the template file (or the default template file) set in the template file setting processing at Step S200, the text object set in the text object replacement processing at Step S300 is applied, and the print image after the application is preview-displayed (See FIG. 18, which will be described later). Then, the routine goes to Step S45.

At step S45, it is determined whether or not the operator has input an instruction to produce the RFID label T through the operation part 102 (by pressing the RFID label producing button 53 in FIG. 6 and the like). If the production instruction of the RFID label T has not been given, the determination is not satisfied, and the routine returns to Step S25 and the similar procedure is repeated. On the other hand, if the instruction to produce the RFID label T has been given, the determination at Step S45 is satisfied, and the routine goes to Step S600.

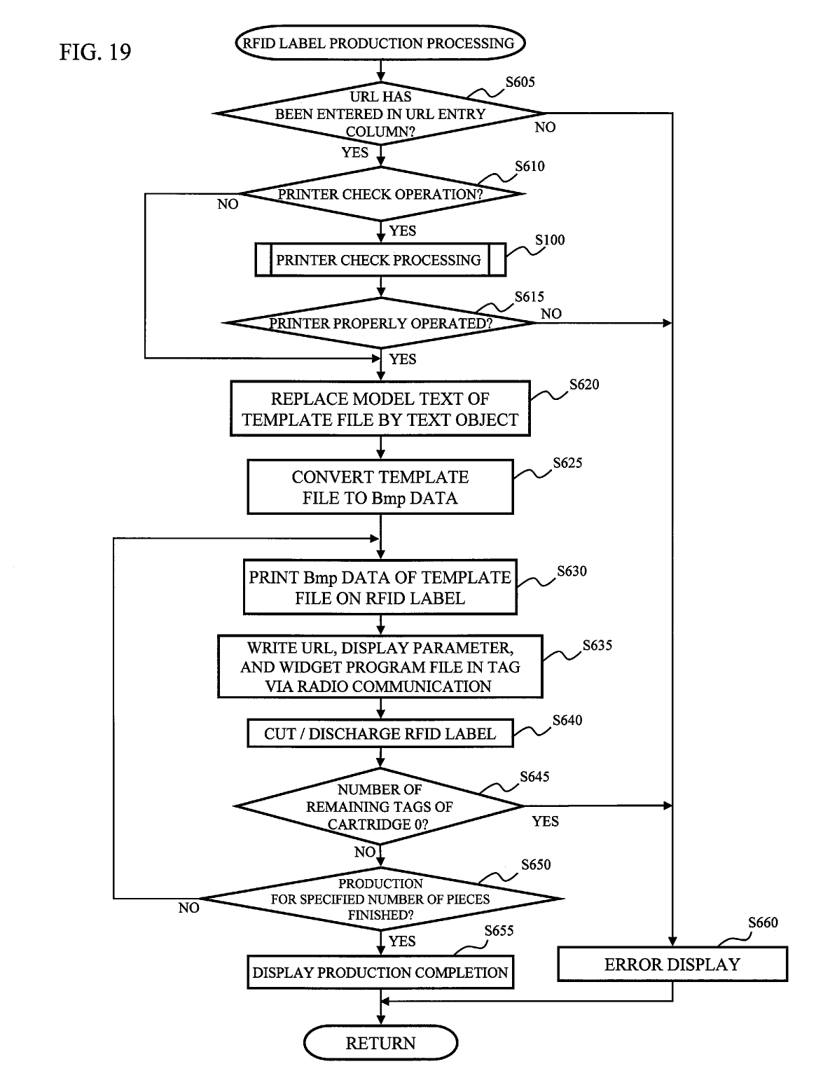

At Step S600, RFID label producing processing is performed. That is, the print image generated by the settings of the template file setting processing at Step S200 and in the text object replacement processing at Step S300 is printed on the tag tape 203. At the same time, the writing information generated by the setting of the writing information setting processing at Step S400 is written in the memory part of the RFID circuit element To through radio communication so as to produce the RFID label T (See FIG. 19, which will be described later). Then, this flow is finished.

FIG. 14 is a flowchart illustrating a detailed procedure of printer check processing executed at Step S100 in FIG. 13.

In FIG. 14, first at Step S105, it is determined whether or not the tag label printer 200 is normally connected to the (writing-side) PC 100 through a connecting device. If normal connection is confirmed, the determination is satisfied, and the routine goes to the subsequent Step S110.

At Step S110, it is determined whether or not the tag label printer 200 is in a normally operable state. If the normally operable state is confirmed, the determination is satisfied, and the routine goes to the subsequent Step S115.

At Step S115, based on a detection signal of a cartridge sensor provided at the tag-tape-roll holder part 210, for example, it is determined whether or not the attached cartridge is a cartridge provided with the tag tape roll 204 with an appropriate tape size (tape width) (determined in advance as an application target of the tag label printer 200). If the tape size provided at the cartridge is appropriate, the determination at Step S115 is satisfied, and the routine goes to the subsequent Step S120.

At Step S120, similarly to the above, based on the detection signal of the cartridge sensor, for example, it is determined if the attached cartridge is a cartridge provided with the tag tape roll 204 with an appropriate type (tape material, type of the RFID circuit element To, arrangement pitch of the RFID circuit elements To and the like) (determined in advance as an application target of the tag label printer 200) or not. If the tape type provided at the cartridge is appropriate, the determination at Step S120 is satisfied, and this flow is finished as a result of the printer check processing is favorable.

On the other hand, if abnormality is detected in the connection of the tag label printer 200 in the determination at Step S105, if abnormality is detected in operation of the tag label printer 200 in the determination at Step S110, if the tape size of the tag tape roll 204 is confirmed to be inappropriate in the determination at Step S115, or if the tape type of the tag tape roll 204 is confirmed to be inappropriate in the determination at Step S120, the determination is not satisfied in each and the routine goes to Step S125. At Step S125, error processing in which error display of that fact is displayed on the display part 101 is performed and this flow is finished as the result of the printer check processing is defective.

FIG. 15 is a flowchart illustrating a detailed procedure of the template file setting processing executed at Step S200 in FIG. 13.

In FIG. 15, first at Step S205, the template file specified by the procedure at Step S30 is detected from the storage device 103 (or may be a recording medium, an external storage device or a database connected to the PC 100) and acquired.

Subsequently, the routine goes to Step S210, where it is determined whether or not the specified template file can be acquired by the procedure at Step S205. If the specified template file can not be acquired, the determination is not satisfied, error display of the fact is made on the display part 101 at Step S215, and this flow is finished. On the other hand, if the specified template file can be acquired, the determination at Step S210 is satisfied, and the routine goes to Step S220.

At Step S220, the specified template file acquired at Step S205 (data constituted by character information to be printed and its display mode information) is converted to bit map data (bit data that can be directly output to the display part 101 and displayed; Abbreviated as “Bmp” in the figure). Since the model text has not been replaced by the text object at this time, the model text is as it is (“Company”, “Title” and the like in the above-mentioned example).

Subsequently, the routine goes to Step S225, where the bit map data converted at Step S220 is displayed on the above-mentioned template file screen 54 (See FIG. 6). By this arrangement, the operator can visually check the contents of the specified template file (size, layout, ruled lines and the like of the print characters corresponding to each model text) (See FIG. 8).

Subsequently, the routine goes to Step S230, where it is determined whether or not the default template file (template file that can be initially set in the program for producing RFID label) is unset. If the default template file has been set, the determination is not satisfied, and the routine goes to the subsequent Step S240. On the other hand, if the default template file has not been set, the determination at Step S230 is satisfied, and the routine goes to Step S235. At Step S235, the specified template file is set as the default template file and the routine goes to Step S240.

At Step S240, it is determined whether or not the text object has been already entered in the entry column 56 of the text object (See FIG. 6). If the text object has not been entered, the determination is not satisfied, and the flow is finished as it is. On the other hand, if the text object has been entered, the determination at Step S240 is satisfied, and the routine goes to Step S245.

At Step S245, it is determined whether or not the operator has input an instruction to totally delete the text object through the operation part 102. If the instruction to fully delete the text object has not been given, the determination is not satisfied, and the flow is finished as it is. On the other hand, if the instruction to fully delete the text object has been given, the determination at Step S245 is satisfied, and all the text objects entered in the entry column 56 are deleted at Step S250 and this flow is finished.

FIG. 16 is a flowchart illustrating a detailed procedure of the text object replacement processing executed at Step S300 in FIG. 13.

In FIG. 16, first, at Step S305, all the entry columns 57 of the model text (See FIG. 6) are opened capable of entry (till then, frames of the entry columns 57 are displayed but entry therein can not be made).

Subsequently, the routine goes to step S310, where the model text input by the operator through the operation part 120 (“Title” indicating the title, “Company” indicating the name of a company, and “00/00/00” indicating the date, for example; See FIGS. 6 and 8 above) is acquired. After that, at the subsequent Step S315, the template file including the acquired model texts are detected from the storage device 103 and the like.

Subsequently, at Step S320, it is determined whether or not detection of the template file is successful by the procedure of Step S315. If the detection failed, the determination is not satisfied, and the routine returns to Step S310 and the similar procedure is repeated. On the other hand, if the detection succeeded, the determination at Step S320 is satisfied, and the routine goes to Step S325.

At Step S325, all the entry columns 56 for text object (See FIG. 6) are opened capable of entry. By this arrangement, the entry columns 57 for the model text which have been opened can not be used any more.

Subsequently, the routine goes to Step S330, where the text object input by the operator through the operation part 102 (“XXX News Topics Sports” corresponding to the “Title”, “brother” corresponding to the “Company”, and “07/10/17” corresponding to the “00/00/00”; see FIGS. 6 and 8 above) is acquired.

Then, at the subsequent Step S335, it is determined whether or not each text object input at Step S330 exceeds the limit number of characters (50 characters in this example). If the limit number of characters is not exceeded, the determination is not satisfied, and the routine goes to Step S340. At Step S340, the background of the entry column 56 for text object (See FIG. 6) is turned to white (indicating a normal state) and this flow is finished. On the other hand, if the limit number of characters is exceeded, the determination at Step S335 is satisfied, the background of the entry column 56 for text object is turned to red (indicating a warning state) at Step S345, and this flow is finished.

FIG. 17 is a flowchart illustrating a detailed procedure of the writing information setting processing executed at Step S400 in FIG. 13.

In FIG. 17, first at Step S405, it is determined whether or not manual input by a keyboard operation on the operation part 102 is allowed for the entry column 55 of the URL of the RSS site (See FIG. 6) in the setting environment (not particularly shown or described) in the program for producing tag. If the URL input by the keyboard operation is allowed, the determination is satisfied, and at Step S410, the URL of the RSS site input by the operator through the operation part 102 (keyboard) is acquired, and the routine goes to Step S460.

On the other hand, the URL input by the keyboard operation is not allowed, the determination at Step S410 is not satisfied, and the routine goes to Step S415. At Step S415, the URL of the RSS site is acquired by a drag-and-drop operation (drag operation, predetermined operation of an operating device) using a pointer device such as a mouse (See FIG. 7).

Subsequently, the routine goes to Step S420, where it is determined whether or not the data input at Step S415 is URL data. If the input data is the URL data, the determination is satisfied, and the routine goes to the subsequent Step S425.

At Step S425, information (including the title of the RSS data and the title of the RSS site) stored in the storage location (that is, the RSS site in the RSS server 7) indicated by the URL is acquired through the communication network 5, and at the subsequent Step S430, it is determined if the acquired information is an XML file or not. If the acquired information is the XML file, the determination is satisfied, and the routine goes to the subsequent Step S435.

AT step S435, it is determined whether or not the format of RSS or RDF (one of RSS versions) is described in the source of the acquired XML file. If RSS or RDF is described in the source of the XML file, the determination is satisfied, that is, the input URL is considered to be that of the RSS site and the information acquired from that is the RSS data, and the routine goes to the subsequent Step S440.

On the other hand, if the input data is not the URL data or not input in appropriate description in the determination of Step S420, if the information acquired in the determination at Step S430 is not an XML file, or if RSS or RDF is not described in the source of the acquired XML file, the determination is not satisfied in each case, and the routine goes to Step S440. At Step S440, error display of that fact is made on the display part 101, and this flow is finished.

At Step S445, the URL input at Step S415 is displayed on the URL entry column 55 (See FIG. 6).

Subsequently, the routine goes to Step S450, where it is determined whether or not the “Title” is entered in the model text and the corresponding text object entry column 56 (See FIG. 6) is blank (that is, not entered yet). If there is no “Title” in the model text or even though there is the “Title” model text, if an arbitrary title has already been entered by the operator as the text object corresponding to it, the determination is not satisfied, and the routine goes to Step S460. On the other hand, if there is the “Title” model text and further if the text object entry column 56 corresponding to it is blank, the determination at Step S450 is satisfied, that is, it is considered that a title to be printed on the RFID label T has not yet been input by the operator, and the routine goes to the subsequent Step S455.

At Step S455, the title of the RSS data acquired at Step S425 (or the title of the acquired RSS site) is entered in the entry column 56 as the text object corresponding to the “Title” model text. By this arrangement, without manual input by the operator of the print contents each time when the RFID label is to be produced, the print contents to the print region is automatically set in correspondence to an access to the RSS data. As a result, storage contents in the RFID circuit element To and the RFID label T visually clarifying the above function based on the storage contents by print can be easily produced. Therefore, convenience for the operator can be improved when the RFID label T for acquiring information from news sites is to be produced.

Then, the routine goes to Step S460, where it is determined whether or not the URL input at Step S410 or Step S415 exceeds the limit number of characters (90 characters in this example) in each case. If the limit number of characters is not exceeded, the determination at Step S460 is not satisfied, the background of the URL entry column 55 is turned into white (indicating a normal state) at Step S465, and this flow is finished. On the other hand, if the limit number of characters is exceeded, the determination at Step S460 is satisfied, the background of the URL entry column 55 is turned into red (indicating a warning state) at Step S465, and this flow is finished.

FIG. 18 is a flowchart illustrating a detailed procedure of the print-screen preview processing executed at Step S500 in FIG. 13.

In FIG. 18, first, at Step S505, by replacing characters of the model text in the template file by those of the text object set respectively corresponding thereto at this time (still in the model text display mode), a template file for display is temporarily generated. If the text object has not been input at this time, the contents of the model text remain as they are.

Subsequently, the routine goes to Step S510, where the template file for display temporarily generated at Step S505 is converted to bit map data.

After that, at the subsequent Step S515, the bit map data converted at Step S510 is displayed on the template file screen 54 (See FIG. 6). By this arrangement, the operator can visually check the contents of the template file for display. Then, this flow is finished.

FIG. 19 is a flowchart illustrating a detailed procedure of the RFID label producing processing executed at Step S600 in FIG. 13.

In FIG. 19, first at Step S605, it is determined whether or not an URL has been already entered in the URL entry column 55 (See FIG. 6). If the URL has not been entered in the URL entry column 55 yet, the determination is not satisfied, error display of that fact is made on the display part 101 at Step S660, and this flow is finished. On the other hand, if the URL has been entered in the URL entry column 55, the determination at Step S605 is satisfied, and the routine goes to the subsequent Step S610.

At Step S610, it is determined whether or not an operator has input an instruction to check an operating state of the tag label printer 200 through the operation part 102. If the instruction to check the printer has not been given, the determination is not satisfied, and the routine goes to Step S620. On the other hand, if the instruction to check the printer has been given, the determination at Step S610 is satisfied, and the routine goes to the subsequent Step S100.

At Step S100, the printer check processing in which connection with the tag label printer 200 and other operating states are checked (See FIG. 14 above) is performed similar to the above. After that, it is determined if a result of the check processing is favorable or not, that is, if the tag label printer 200 is in an appropriately operable state or not at Step S615.

If the result of the printer check processing is defective, the determination at Step S615 is not satisfied, that is, it is considered that some failure occurs at the tag label printer 200 and the printer can not be properly operated, and the fact is displayed on the display part 101 at Step S660 and this flow is finished. On the other hand, if the result of the printer check processing is favorable, the determination at Step S615 is satisfied, and the routine goes to the subsequent Step S620.

At Step S620, characters of the model text in the template file are replaced by those of the text objects respectively corresponding thereto so as to produce a template file for production. After that, at the subsequent Step S625, the template file for production produced at Step S620 is converted to bit map data.

Then, the routine goes to Step S630, where information of the bit map data in the template file for production is output to the print head 205. Specifically, bit alignment of the bit map data is realigned corresponding to a feeding direction of the tag tape 203 and sequentially output to a heater element of the print head 205, for example. By this arrangement, image contents of the template file for production is printed on the surface of the tag tape 203 (See FIG. 9, which will be described later). An operation of the feeding apparatus 209 has been already started at this time and feeding and stop of the tag tape 203 is controlled appropriately.

Subsequently, the routine goes to Step S635, where in the RSS region, the parameter region, and the application region in the memory part 155 of the RFID circuit element To provided in the tag tape 203, the URL of the RSS site, the display parameters (produced by a separate device, though not particularly described), and the widget program file (the program of the news ticker widget in the example of this embodiment) are written, respectively, via radio communication through the device antenna 206. Then, at the subsequent Step S640, cutting and discharge of the tag tape 203 is carried out so as to issue the RFID label T.

Subsequently, the routine goes to step S645, where it is determined if the remaining number of the RFID circuit elements To in the cartridge is 0 or not. For this count, such a method may be used that at the first attachment of the cartridge to the tag-tape-roll holder part 210, after the total number of the RFID circuit elements To of an unused cartridge is detected by a detection result of the cartridge sensor, the total number is reduced according to the number of produced labels. Alternatively, such a method may be used that sequential number information indicating the sequential number in alignment in the tag tape 203 in the cartridge is acquired from each of the RFID circuit elements To via radio communication. Count may be made using other appropriate methods. If there is no RFID circuit element To left in the tag tape roll 204, the determination is satisfied, that is, it is considered that the cartridge should be replaced since the attached cartridge is not capable of producing the RFID label T any more, error display of that fact is made on the display part 101 at Step S660, and this flow is finished. On the other hand, if the RFID circuit element To remains in the tag tape roll 204, the determination at Step S645 is not satisfied, and the routine goes to the subsequent Step S650.

At Step S650, it is determined whether or not production of the RFID labels T in the number specified by a separate setting operation (operation through the operation part 102, for example. Not particularly shown) has been finished. If the specified number of labels has not been reached yet, the determination is not satisfied, and the routine goes to Step S630 and the similar procedure is repeated. On the other hand, if the production of the RFID labels T in the specified number has been finished, the determination at Step S650 is satisfied, display of the fact that the production of the RFID label T has been finished is made on the display part 101 at the subsequent Step S655, and this flow is finished.

In the above, the radio frequency circuit 201 provided at the tag label printer 200 constitutes an information writing portion described in each claim, and the radio frequency circuit 201, the print head 205, and the feeding apparatus 209 constitute an issuance processing portion. The procedure at Step S425 in the flow of FIG. 17 executed by the PC 100 functions as a title acquisition portion, and the procedure at step S450 functions as a print contents determining portion.

In the embodiment configured as above, the tag label printer 200 is provided with the device antenna 206 capable of information transmission/reception with the RFID circuit element To and executes the RFID label production processing that issues the RFID label T. At this RFID label production processing, through the device antenna 206, the URL of the RSS data including the URL of the predetermined news site (storage location information), the news ticker widget program configured to perform the predetermined display processing, and the display parameters are written in the IC circuit part 151 of the RFID circuit element To.

Then, these are all read out through the reader antenna 401 of the tag reader 400. For example, in a state where the widget program is first read out of the IC circuit part 151 (and installed), the URL of the RSS site is read out of the IC circuit part 151. Then, in the reading-side PC 300, the RSS data is acquired from the URL and based on the URL included in the RSS data, the predetermined news site is accessed and the site information is acquired. The site information from the news site acquired as above is displayed on the display part 301 in a display mode corresponding to the acquired display parameter.

As a result, the operator can have the site information provided by the desired news site automatically displayed on the display part 301 on the reading-side PC 300 only by conducting the information reading of the RFID label T by the reader antenna 401. At this time, since the display mode is automatically controlled based on the display parameter, a width of expression can be widened. As a result, display in a mode as close as possible to the intension of an information provider of the news site or display according to the needs or intended purpose of the operator (display on the lowermost line as described above and the like) can be easily realized, for example. As mentioned above, the URL of the news site is not directly written in the RFID label T but the URL of the RSS data including the URL of the site is written therein and an access is made to the RSS data by the information reading out of the RFID label T. By this arrangement, unlike the direct access to the URL of the news site, even if information change or information update of the news site is carried out, an assured access can be made to the news site and the latest information can be acquired and displayed.

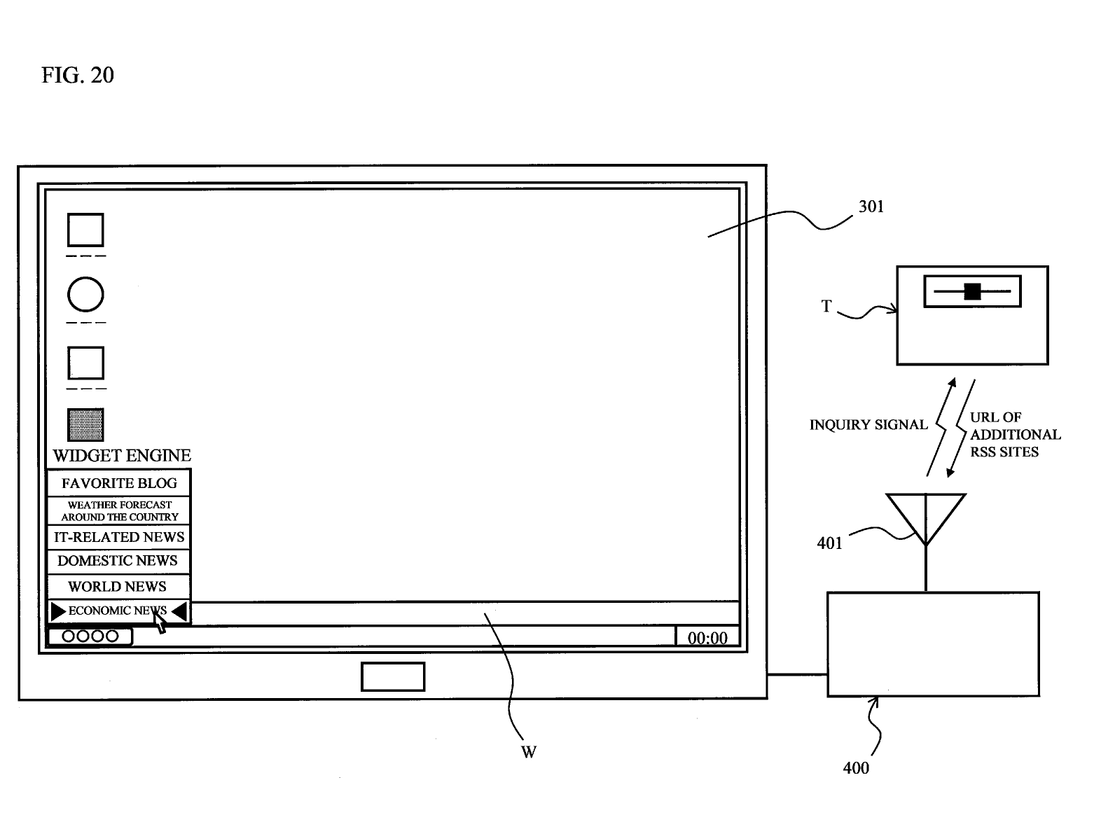

In the above embodiment, such an example is shown that only one URL of the RSS site as a destination to acquire the RSS data is written in the RSS region in the memory part 155 of the RFID circuit element To of a single RFID label T, but not limited to that. For example, such a method may be used that by recording respective URLs of a plurality of RSS sites in the RSS region in the memory part 155, the URLs of the plurality of RSS sites are read out, the RSS data is acquired from each of the RSS sites and an access is made to the news site with the URL included in the RSS data so that the respective site information is acquired/displayed. At this time, a plurality of URLs may be made to correspond to a single piece of RSS data or a single URL may be made to correspond to the plurality pieces of RSS data. In any case, by using a single RFID label T, site information of a plurality of (or a single) news site can be displayed through a plurality of pieces of (or a single piece of) RSS data. As a result, as compared with a case where one RFID label T each is required for each RSS site, convenience of the operator is improved. Also, the display mode can be changed according to the RSS data (for each RSS site or for each news site). In this case, as shown in FIG. 20, for example, a plurality of RSS sites may be cumulatively registered by the news ticker widget so that the operator can make selection and switching as appropriate.

In the above embodiment, such a case is shown that only one widget program is written in the application region in the memory part 155 of the RFID circuit element To of a single RFID label T, but not limited to that. For example, such a method may be used that by recording a plurality of widget programs in the application region of the memory part 155, the plurality of widget programs are read out, the RSS data is acquired from each RSS site, an access is made to a news site with the URL included in the RSS data and respective site information is acquired, and the site information is displayed by the plurality of widget programs, respectively. At this time, not that the RSS data, the URL, and the widget program are made to correspond one by one as above, but it is possible to have the plurality of widget programs correspond to a single piece of RSS data, a single (or a plurality of) URL(s) or to have a single widget program correspond to the plural pieces of RSS data, a single (or plurality of) URL(s). In any case, by using a single RFID label T, the site information of the news site can be displayed using a plurality of widget programs (or a single widget program), by which convenience of the operator is further improved. It also becomes possible to change a widget program to be used for each of the plural pieces of RSS data (for each RSS site or for each news site), and as compared with a case where separate RFID labels T should be prepared for each, convenience of the operator can be improved.

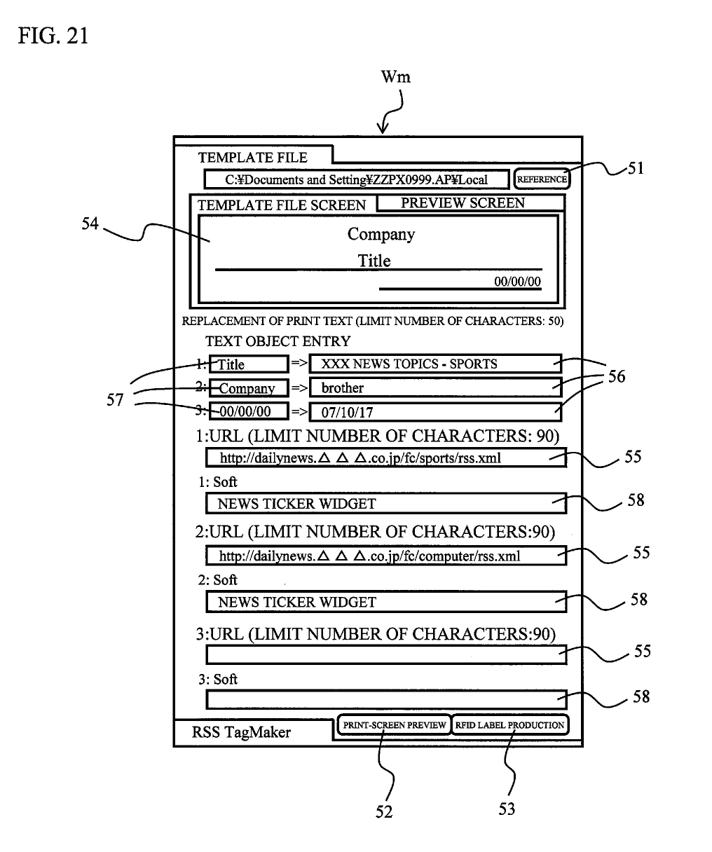

Also, in this case, such a method may be used that each of the plurality of RSS sites is made to correspond to each of the plurality of widget programs so that the site information of the news site is displayed on the display part 301 using the widget program corresponding to each RSS site. In this case, as shown in FIG. 21, an entry column 58 for a widget program corresponding to each of the URL entry columns 55 for a plurality of RSS sites (three in the illustrated example) may be provided in the program Wm for producing tag for input (in the illustrated example, only two combinations are entered).

By this arrangement, as mentioned above, it becomes possible to change the widget program to be used for each of the plurality of RSS sites or news sites, and display contents the most suitable for the site information provided by the site can be surely realized. Also, with regard to correspondence between the RSS site and the news site, as mentioned above, the display may be made in one for n (n is an integer of 2 or more, that is, a plural number), that is, selection may be made from n-number of the plurality of widgets to a single RSS site or n for 1, that is, display may be made by a single widget by selecting from n-number of RSS sites, or n for n, that is, display may be made with n-number of different widgets corresponding to n-number of different RSS sites, respectively.

Moreover, writing may be made in the RFID circuit element To in a form in which a plurality of types of display modes included in the display parameter, URLs of a plurality of pieces of RSS data, and a plurality of widget programs are associated with each other. In this case, in the program Wm for producing tag in FIG. 21, for example, an entry column (not particularly shown in FIG. 21) specifying a display mode corresponding to each combination of the URL entry column 55 of the RSS site and the entry column 58 of the widget program may be provided for input.

By this arrangement, when the site information from a news site is to be displayed on the display part 301 using an acquired widget program, display contents the most suitable for the information provided from the news site can be surely realized by changing the widget program and the display mode to be used for each of the plurality of news sites.

Also, particularly in this embodiment, as the display parameter, at least information of a display position specifying a display portion in the display part 301 is written in the RFID circuit element To. By this arrangement, when the site information from the news site is to be displayed on the display part 301 using the installed news ticker widget program, the reading-side PC 300 can surely make display at a display position as close as possible to an intension of an information provider of the news site, display at an optimal position according to the needs or intended use of the operator, for example.

In the above embodiment, access timing information relating to timing when the news ticker widget of the reading-side PC 300 accesses the RSS data based on the URL of the RSS data or timing when accessing each news site based on the URL described in the RSS data (including the first timing and the subsequent update interval) may be also written in the RFID circuit element To through the device antenna 206 in the procedure at Step S635 in the flow of FIG. 19.

By this arrangement, when the reading-side PC 300 displays the site information from the news site on the display part 301 using the news ticker widget program, access timing to the site information of the RSS data or each news site (in other words, the access timing to the RSS site or news site) can be set appropriately. Also by this arrangement, an access can be made to a news site periodically with an appropriate interval so as to acquire and display the latest information from the site all the time, by which convenience of the operator can be improved.

In the above, an example was described in which information writing or print is made to the tag tape 203 while being moved, but not limited to that. The tag tape 203 and the like may be stopped at a predetermined position (and moreover, the writing may be held by a predetermined feeding guide) so that the above print or writing can be made.

In the above, an example was described in which the tag tape 203 for which print and an access to (writing in) the RFID circuit element To has been finished is cut by the cutter 207 so as to produce the RFID label T, but not limited to that. That is, if a label mount (so-called die cut label) separated in advance to a predetermined size corresponding to a label is continuously arranged on a tape fed out of a roll, it may be so configured that only the label mount (provided with the accessed RFID circuit element To and on which the corresponding print has been made) is peeled off the tape so as to produce the RFID label T after the tape is discharged from a carry-out exit even without cutting the tape by the cutter 207, and the present invention can be also applied to such configuration.

In the above, such a method was used in which a print is made on a print-receiving tape layer provided at the tag tape 203 (type in which bonding is not carried out), but not limited to that, the present invention may be applied to a method that a print is made to a cover film (print-receiving medium) separate from the tag tape 203 provided with the RFID circuit element To and they are bonded together. Moreover, the present invention is not limited to those in which the RFID tag information is written from the IC circuit part 150 of the RFID circuit element To and print to identify the RFID circuit element To is made by the print head 205. The print does not necessarily have to be made, and the present invention may be applied to those in which only writing of the RFID tag information is carried out.

Moreover, in the above, such an example was described in which the tag tape 203 is wound around a reel member so as to constitute a roll, and the roll is arranged in the cartridge and the tag tape 203 is fed out, but not limited to that. For example, a lengthy flat-sheet state or strip-state tape or sheet (including those formed by cutting a tape wound around the roll is fed out and then, cut into an appropriate length) on which at least one RFID circuit element To is arranged is stacked in a predetermined storage portion (flatly laminated in a tray-like container, for example) to be made into a cartridge, and this cartridge is attached to a cartridge holder on the side of the tag label printer 200 so that the tape is transferred and transported from the storage portion and printed and written so as to produce the RFID label T.

Moreover, there may be a configuration that the roll is directly and detachably attached to the side of the tag label printer 200 or a configuration that the lengthy flat-sheet state or strip state tape or sheet is transferred from outside the tag label printer 200 one by one by a predetermined feeder mechanism and supplied into the tag label printer. Moreover, not limited to those detachably attached to the side of the tag label printer 200 body such as a cartridge, the roll of a tape with RFID tag may be provided on the side of the apparatus body in a so-called installed or integrated type not capable of detachment. In this case, too, the same effect is obtained.

Other than those mentioned above, methods of the embodiments and their variations may be combined as appropriate for use.

Though not specifically exemplified, the present invention should be put into practice with various changes made in a range not departing from its gist.

What is claimed is:

1. An apparatus for producing RFID tag comprising:
a communication device configured to be able to transmit/receive information with respect to a RFID circuit element provided with an IC circuit part storing information and a tag antenna configured to transmit/receive information; and
an issuance processing portion configured to execute issuance processing of a RFID tag using a tag medium provided with said RFID circuit element in which storage location information of RSS data relating to a predetermined information providing site and a widget program for performing display processing are written through said communication device, said display processing being for displaying information provided at said information providing site in a predetermined display mode.

2. The apparatus for producing RFID tag according to claim 1, wherein:
said issuance processing portion includes:
a feeding device configured to feed said tag medium;
an information writing portion configured to write at least said storage location information of the RSS data and said widget program in said RFID circuit element through said communication device; and
a printing device configured to make a desired print on said tag medium or a print-receiving medium to be bonded to said tag medium.

3. The apparatus for producing RFID tag according to claim 2, wherein:
said information writing portion writes one or more of said storage location information of the RSS data relating to one or more of said information providing sites in said RFID circuit element through said communication device.

4. The apparatus for producing RFID tag according to claim 3, wherein:
said information writing portion writes one or more of said widget programs in said RFID circuit element through said communication device.

5. The apparatus for producing RFID tag according to claim 4, wherein:
said information writing portion writes one or more of said storage location information of the RSS data and one or more of said widget programs in a form associated with each other in said RFID circuit element through said communication device.

6. The apparatus for producing RFID tag according to claim 5, wherein:
said information writing portion writes display instruction information relating to said display processing performed by said widget program in said RFID circuit element through said communication device.

7. The apparatus for producing RFID tag according to claim 6, wherein:
said information writing portion writes one or more types of said display modes included in said display instruction information, said one or more of storage location information of the RSS data, and said one or more of widget programs in a form associated with each other in said RFID circuit element through said communication device.

8. The apparatus for producing RFID tag according to claim 6, wherein:
said information writing portion writes at least display position information specifying a display portion in a display device as said display instruction information in said RFID circuit element through said communication device.

9. The apparatus for producing RFID tag according to claim 6, wherein:
said information writing portion writes access timing information relating to timing to access said RSS data based on said storage location information of RSS data or timing to access each information providing site based on the storage location information described in the RSS data in said RFID circuit element through said communication device.

10. A RFID tag editing apparatus capable of editing print contents by a printing device to a predetermined print region provided at a tag medium provided with said RFID circuit element in which storage location information of RSS data relating to a predetermined information providing site and a widget program for performing predetermined display processing relating to information provided at said information providing site are written or a print-receiving medium to be bonded to said tag medium, said apparatus comprising:
a display device configured to display contents of the RSS data relating to the predetermined information providing site;
a title acquisition portion configured to acquire a title of said RSS data whose contents are displayed on said display device; and
a print contents determining portion configured to determine the print contents by said printing device to said print region based on the title of said RSS data acquired by said title acquisition portion.

11. The RFID tag editing apparatus according to claim 10, wherein:
said print contents determining portion determines said print contents according to a predetermined operation of an operating device in a state where the contents of said RSS data is displayed on said display device.

12. The RFID tag editing apparatus according to claim 11, wherein:
said print contents determining portion determines said print contents according to a drag operation to a display region for said storage location information of the RSS data on said display device as said predetermined operation.
